(19) United States
(12) Patent Application Publication
(10) Pub. No.: US 2010/0033169 A1
(43) Pub. Date: Feb. 11, 2010

(54) Position Detector

(75) Inventors: Hirofumi Horibe, Gifu (JP); Tetsuya Sakai, Gifu (JP)

Correspondence Address: Cozen O''Connor, 250 PARK AVENUE, NEW YORK, NY, 10177, US

(73) Assignee: Nippon Thompson Co., Ltd., Tokyo (JP)

(21) Appl. No.: 12/511,445

(22) Filed: Jul. 29, 2009

(30) Foreign Application Priority Data
Aug. 6, 2008 (JP) 2008-202726

(51) Int. Cl. G01D 5/18

(52) U.S. Cl. 324/207.24

(57) ABSTRACT

A position detector can correct a position for detecting a moving object without changing a physical location of a moving mechanism, a Hall element and/or the like. Either a permanent magnet 19 or Hall elements 16a, 17a, 17b, 17c is mounted on a moving object 3 moving along a fixed movement path, and the other of them is mounted on the fixed movement path of the moving object 3. A voltage output from each Hall element is detected based on an electromotive force induced in the Hall element in accordance with a facing position between the permanent magnet and the Hall element, for detection of the position of the moving object. A comparison unit a2 outputs a detection signal for the moving object when the voltage value output from the Hall element exceeds a threshold, and comprises a variable controlling unit R for variably controlling the threshold.

### BACKGROUND OF THE INVENTION

1. Field of the Invention

This invention relates to a position detector for detecting a position of a moving object moving along a fixed path of movement.

2. Description of the Related Art

For example, a treatment apparatus used for manufacturing semiconductors or the like moves a moving object with a workpiece placed thereon to a predetermined location for treating the workpiece, and is required to precisely dispose the workpiece in position.

To achieve the determination of the precise position of a workpiece as described above, the present applicant has proposed a small slider unit using Hall elements for position detection as a workpiece moving mechanism in such a treatment apparatus in Japanese Patent Application No. 2008-009223.

This conventional small slider unit is provided with a position detector having a permanent magnet attached on a slide table and Hall elements mounted on the rail for guiding the slide table. In such a position detector, for example, a Hall element is placed precisely in alignment with the zero point of the treatment apparatus for detecting the alignment of the slide table with the zero point of the treatment apparatus. When the permanent magnet on the slide table directly faces the Hall element, that is, when the Hall element outputs a peak voltage, it is determined that the slide table, that is, the workpiece is precisely aligned with the treatment apparatus. For reference, another type of slider unit is disclosed in Japanese Patent No. 3927285, for example.

In conventional position detectors as described above, the position in which the Hall element outputs a peak voltage is defined as the zero point at which the slide table must stop. However, if the mounting position of the Hall element deviates even slightly from the zero point of the treatment apparatus, the position in which the peak voltage is output deviates from the zero point. In particular, when the treatment apparatus and the slider unit comprising a rail and a slide table are installed independently of each other, installation errors and the like are apt to cause a positional deviation between the slider unit and the treatment apparatus relative to each other, resulting in deviation between the Hall element and the zero point of the treatment apparatus.

Such relative position deviation is found only after the slider unit and the treatment apparatus have been installed. For this reason, a method for correcting the relative position between the slider unit and the treatment apparatus is, for example, to correct the position of either the slider unit or the Hall element. In either case, the required amount of correction is very small, making the deviation correction significantly difficult.

For example, for correction to be made on the position of a moving mechanism such as a slider unit, the slider unit is removed from the location where it has been mounted and moved to the correct location. These steps involve an enormous amount of effort and time, and also give rise to the difficulty of maintaining the precision even if the slider unit can be successfully re-installed.

On the other hand, the correction made only on the position of the Hall element involves the difficulty of positional adjustment because the Hall element itself is extremely small.

The problems as described above arise similarly when the aforementioned slider unit is mounted on various apparatuses requiring precise positional management such as a semiconductor manufacturing apparatus, a treatment apparatus, a machining apparatus and the like.

### SUMMARY OF THE INVENTION

It is an object of the present invention to provide a position detector which is capable of correcting the position for detecting a moving object without changing the physical location of a moving mechanism, a Hall element and/or the like.

To attain this object, the present invention provides a position detector which is provided with either a permanent magnet or Hall elements mounted on a moving object which moves along a fixed path of movement, with the other of two, the permanent magnet and the Hall elements, mounted on the fixed path of movement of the moving object, and detects a voltage output from each of the Hall elements on the basis of an electromotive force induced in the Hall element in accordance with a facing position between the permanent magnet and the Hall element in order to detect the position of the moving object. The position detector is characterized by a comparison unit which compares a voltage value supplied from the Hall element with a threshold, outputs a detection signal when the voltage value exceeds the threshold for detection of a position of the moving object from a position in which the detection signal is output, and comprises a variable controlling unit for variably controlling the threshold.

In the present invention, the variable controlling unit preferably comprises a variable resistance.

In the present invention, an amplification unit is preferably provided between the Hall element and the comparison unit for amplifying a voltage supplied from the Hall element and outputs the voltage thus amplified.

According to the present invention, a position for detecting the moving object can be adjusted by adjusting the threshold in the comparison unit, as is the case of moving the location of the Hall element.

In other words, without physically relocating the Hall element, it is possible to change the position for detecting the moving object, adjust the zero point of a treatment apparatus in which the moving object is mounted, and the like.

According to the present invention, the provision of the amplification unit makes it possible to detect a voltage output from the Hall element as a signal even when the voltage is very low. For example, even when the Hall element and the permanent magnet are at location some distance from each other, the detection of the position of the moving object is made possible.

### BRIEF DESCRIPTION OF THE DRAWINGS

FIG. 1 is a system block diagram of an embodiment according to the present invention.

FIG. 2 is a front view of a slider unit in the embodiment.

FIG. 3 is a sectional view taken along the III-III line in FIG. 2.

FIG. 4 is a plan view of a mounting base of the slider unit.

FIG. 5 is a schematic diagram of an amplifier circuit in the embodiment.

FIG. 6 is a graph showing a voltage value (1) input to a comparison unit on the basis of position detection and a detection signal (2) output from the comparison unit when the zero point of a treatment apparatus is aligned with the zero point of the position detector.

FIG. 7 is a graph showing a voltage value (3) input to a comparison unit on the basis of position detection and a detection signal (4) output from the comparison unit when the zero point of the treatment apparatus is not aligned with the zero point of the position detector.

### BEST MODE FOR CARRYING OUT THE INVENTION

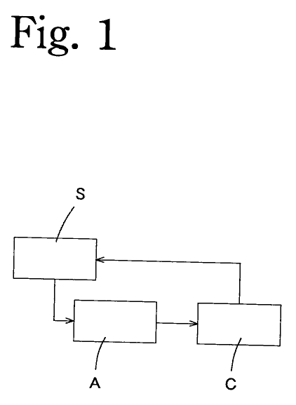

FIGS. 1 to 7 illustrate an embodiment according to the present invention which is a system in which a slider unit S is mounted to a treatment apparatus. The slider unit S utilizes a position detector of the present invention.

FIG. 1 is a block diagram of the system comprising a slider unit S, an amplifier circuit A and a controller C. Upon reception of a voltage output from a later-described Hall element mounted on the slider unit S, the amplifier circuit A supplies a detection signal in accordance with the voltage value to the controller C.

The controller C has the function of controlling the driving of the slider unit S in response to the position detection signal supplied from the amplifier circuit A. The controller C may additionally have the function of controlling the treatment apparatus (not shown) in which the slider unit S is mounted.

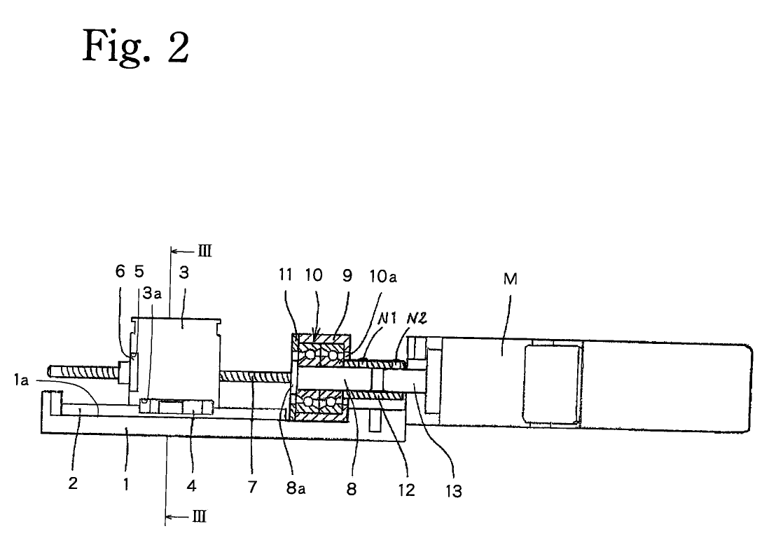

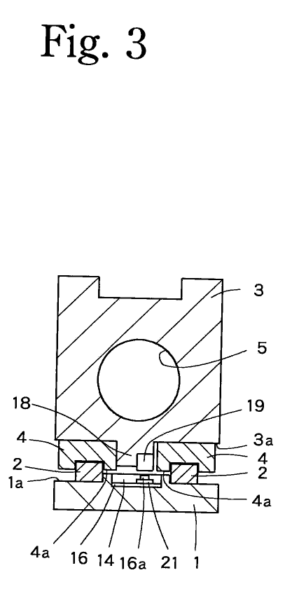

The slider unit S described here is a small slider unit disclosed in Japanese Patent Application No. 2008-009223 filed by the present applicant. As shown in FIGS. 2 and 3, a pair of parallel rails 2 are attached to a mounting face 1a of a mounting base 1. A slide table 3 moves along the rails 2. Specifically, the slide table 3 has a face 3a facing the mounting face 1a and C-shaped cross-section guide members 4 provided on the face 3a, such that the guide members 4 straddle and can slide on the respective rails 2.

A screw shaft 7 has an end fixedly press-fitted into a cap member 8. The cap member 8 is supported by an angular bearing 10 which is housed in a casing 9 fixed on the mounting base 1, in order to keep the axis of the screw shaft 7 in position. The mounting base 1 is fixedly attached to a predetermined location on the treatment apparatus.

A lid member 11 is fixed to an open end of the hole drilled in the casing 9 in order to prevent the angular bearing 10 from falling out of the casing 9.

On the opposite end of the casing 9 from the cap member 8, a coupling member 12 is provided. A rotating shaft 13 of a motor M is inserted into the coupling member 12 and locked to the coupling member 12 with a set screw N2 so that the coupling member 12 and the rotating shaft 13 rotate in one piece.

The angular bearing 10 has an inner ring 10a into which the cap member 8 is inserted, such that a flange 8a of the cap member 8 makes contact with the inner ring 10a and the other end of the cap member 8 opposite to the flange 8a end extends outward from the inner ring 10a. This protruding portion of the cap member 8 is fitted into the coupling member 12. The coupling member 12 and cap member 8 are locked together by a set screw N1 so as to rotate in one piece.

By locking the coupling member 12 in this manner, the angular bearing 10 is fixedly interposed between the coupling member 12 and the flange 8a. As a result, the cap member 8 and the screw shaft 7 with the cap member 8 fixed thereto are inhibited from rattling in the axis direction.

Next, FIG. 3 illustrates the slide table 3 which has a hole 5 drilled therethrough in the axis direction of the rail 2. A ball nut 6 is fixed in the hole 5 so that a screw connection is made between the ball nut 6 and the screw groove of the screw shaft 7.

Thus, as the motor M is driven so as to rotate the rotating shaft 13, the screw shaft 7 is also rotated. This rotation of the screw shaft 7 moves a combination of the ball nut 6 and the slide table 3 along the rail 2. That is, in the embodiment, the slide table 3 is the moving object of the present invention and the rail 2 is the fixed path of movement of the present invention.

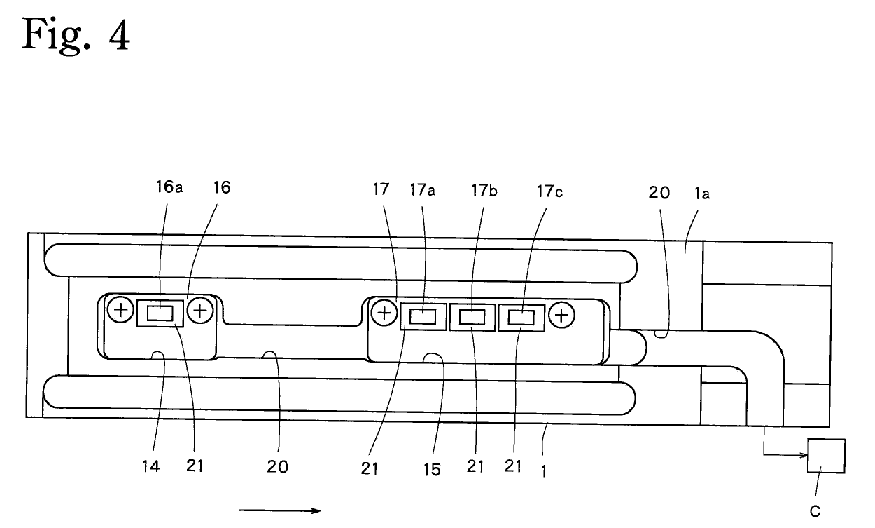

The next figure, FIG. 4, illustrates the mounting face 1a of the mounting base 1 in which mounting recesses 14, 15 are formed. Boards 16, 17 are respectively attached to the mounting recesses 14, 15. A Hall element 16a is mounted on the board 16, while three Hall elements 17a, 17b, 17c are mounted in order on the board 17 in the longitudinal direction of the rail 2.

The boards, the mounting recesses and the Hall elements are designed to maintain a dimensional relationship such that, when the boards 16, 17 are attached to the mounting recesses 14, 15, the top faces of the respective Hall elements 16a, 17a, 17b, 17c, that is, the faces facing the slide table 3, do not protrude from the mounting recesses 14, 15.

FIG. 4 also illustrates soldering areas 21 for mounting the Hall elements 16a, 17a, 17b, 17c on the boards 16, 17.

A plurality of wires connected to the power source (not shown) are connected to the boards 16, 17. During the passage of current through the Hall elements 16a, 17a, 17b, 17c, when a magnetic field is applied to each of the Hall elements, an electromotive force (Hall voltage) is induced. The voltage based on the electromotive force is applied to the amplifier circuit A through the wire. The wires connected to the respective Hall elements are housed in a wiring recess 20 formed in the mounting face 1a (see FIG. 4).

Referring back to FIG. 3, a protrusion 18 protrudes from the face 3a of the slide table 3 toward the mounting face 1a of the mounting base 1. A permanent magnet 19 is fixed on the protrusion 18 such that the permanent magnet 19 faces each of the Hall elements 16a, 17a, 17b, 17c on the boards 16, 17 as the slide table 3 moves along the rails.

Accordingly, each of the Hall elements 16a, 17a, 17b, 17c through which a current is passed outputs the highest voltage when directly facing the permanent magnet 19.

In the embodiment, of the four Hall elements provided, the Hall elements 16a and 17c function as the limit sensors for detecting the stroke ends of the slide table 3, and the Hall element 17b functions as a zero-point sensor for detecting the zero point which is the home position of the slide table 3 when the treatment apparatus is powered on. In addition, the Hall element 17a functions as a pre-zero-point sensor for detecting that the slide table 3 comes close to the zero point when the slide table 3 moves in the direction indicated by the arrow in FIG. 4.

Such a pre-zero-point sensor is provided for the purpose of precisely stopping the slide table 3 at the zero point. For example, in the movement of the slide table 3 from the left stroke end shown in FIG. 4 in the arrow direction, when the Hall element 17a functioning as the pre-zero-point sensor detects the slide table 3, the rotational speed of the motor M is decreased to decrease the moving speed of the slide table 3. This makes it possible to stop the motor M at the time when the Hall element 17b serving as the zero-point sensor detects the slide table 3 in order to immediately stop the moving slide table 3. In addition, the slide table 3 can be moved at high speed until the pre-zero-point sensor detects the slide table 3.

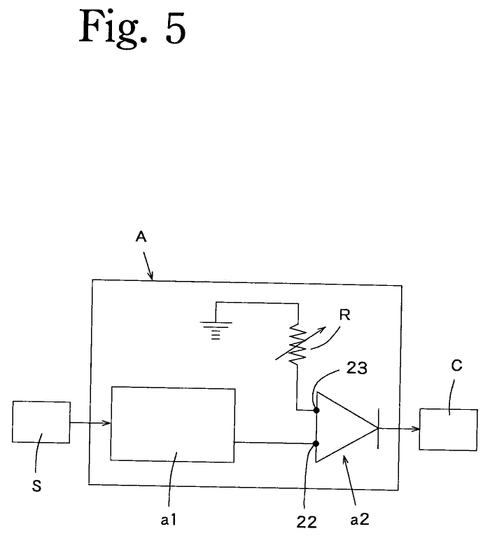

On the other hand, the amplifier circuit A is designed to supply a position detection signal in accordance with the voltage supplied from each of the Hall elements 16a, 17a, 17b, 17c. The amplifier circuit A, as shown in FIG. 5, comprises an amplification unit a1 which amplifies the voltage output from each of the Hall elements 16a, 17a, 17b, 17c of the slider unit S, and a comparison unit a2 which compares the voltage value obtained by the amplification by the amplifier a1 with a threshold and outputs a detection signal.

The comparison unit a2 compares the voltage received at a terminal 22 from the amplification unit with a threshold voltage received at a terminal 23. As a result of the comparison, when the voltage value received at the terminal 22 exceeds the threshold voltage, the comparison unit a2 outputs to the controller C a detection signal which indicates that the slide table 3 has been detected.

The terminal 23 is connected to a variable resistance R which forms the variable controlling unit of the present invention, so that the threshold can be changed by changing the resistance value of the variable resistance R. Specifically, a knob is provided for manually adjusting the variable resistance.

FIG. 5 shows a single amplification unit a1 and a single comparison unit a2, but an amplification unit a1 and a comparison unit a2 are required to be provided for each Hall element.

Next, the operation of the embodiment will be described. The position detector of the embodiment comprises four Hall elements 16a, 17a, 17b, 17c to achieve detection of the slide table 3 in four sites. Because each of these Hall elements operates on the same principle of position detection, the following describes the Hall element 17b functioning as the zero-point sensor by way of example.

For operating the Hall element 17b as the zero-point sensor, the mounting base 1 of the slider unit S is attached to the treatment apparatus such that the Hall element 17b is aligned with the zero point of the treatment apparatus.

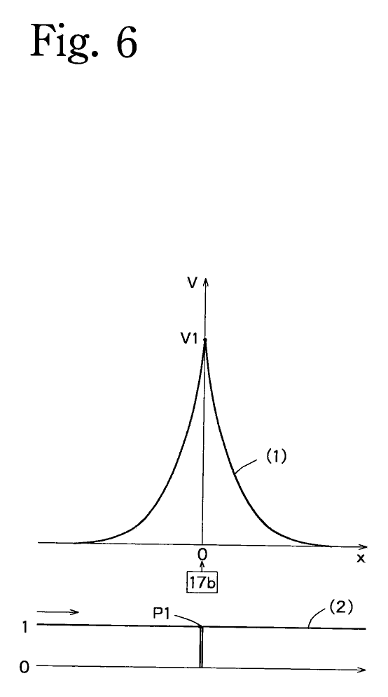

As the slide table 3 moves closer to the Hall element 17b, an electromotive force is induced in the Hall element 17b, and the voltage output from the Hall element 17b reaches the maximum value when the slide table 3 directly faces the Hall element 17b. Accordingly, the voltage value supplied to the comparison unit a2 of the amplifier circuit A after the amplification in the amplification unit a1 also reaches a peak voltage value V1 when the Hall element 17b directly faces the permanent magnet 19, as shown in graph (1) in FIG. 6.

The x axis in FIG. 6 shows positions in the axis direction of the treatment apparatus, and FIG. 6 shows the Hall element 17b aligned with the zero point in the axis direction of the treatment apparatus. Graph (1) in FIG. 6 shows voltage values input to the terminal 22 of the comparison unit a2 shown in FIG. 5 which are based on the voltage values output from the Hall element 17b assigned for detection of the zero point. Graph (2) shows the detection signal output from the comparison unit a2 to the controller C.

In the embodiment, the amplifier circuit A outputs a “zero” signal as the detection signal at the time when the slide table 3 is detected at the zero point. That is, the amplifier circuit A outputs a “1” level signal as long as the slide table 3 is not detected, and stops outputting the “1” level signal at the time when the slide table 3 is detected. In the embodiment, a “1” level signal is normally output and when the outputting of the “1” level signal stops, this means the outputting of a “0” level detection signal.

In this manner, as long as the Hall element 17b is exactly aligned with the zero point of the treatment apparatus, the slide table 3 comes to rest in a position corresponding to the zero point of the treatment apparatus when the permanent magnet 19 of the slide table 3 directly faces the Hall element 17.

For this purpose, if the threshold of the comparison unit a2 is set to a value approximately equal to the peak voltage value V1, the comparison unit a2 outputs a detection signal at the time when the slide table 3 directly faces the Hall element 17b, that is, at point P1 on the graph (2) in FIG. 6. As a result, the controller C can detect from the detection signal supplied from the amplifier circuit A that the slide table 3 has reached the zero point.

However, when the mounting base 1 of the slider unit S is installed in the treatment apparatus as described above, it is difficult to exactly align the Hall element 17b fixedly attached to the mounting base 1 with the zero point of the treatment apparatus, thus possibly causing a slight misalignment.

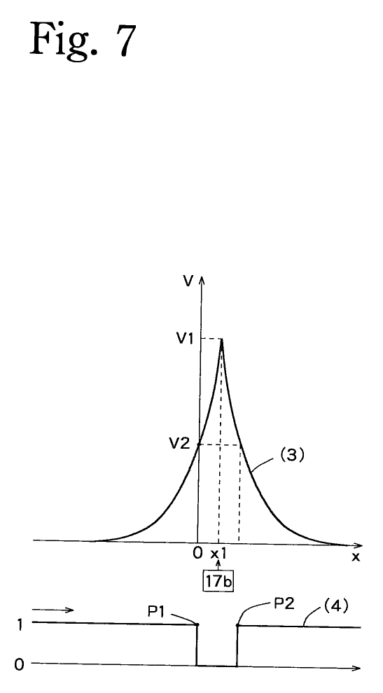

For example, as shown in FIG. 7, if the Hall element 17b is mounted in a position deviating by a distance x1 from the zero point of the treatment apparatus, this results in the application of the peak voltage value V1 to the comparison unit a2 of the amplifier circuit A when the slide table 3 reaches a position deviating by a distance x1 from the treatment apparatus.

In other words, when the slide table 3 is at the zero point of the treatment apparatus, the comparison unit a2 receives a voltage value V2 which is smaller than the peak voltage value V1.

Since the conventional position detector described earlier is configured to supply a detection signal indicative of the detection of the slide table 3 to the controller C only when receiving the peak voltage value V1, a detection signal is not output when the voltage value V2 is input.

However, the amplifier circuit A according to the embodiment is capable of changing the threshold voltage set in the comparison unit a2 by adjusting the variable resistance R. Accordingly, when the Hall element 17b of the slider unit S is located at a distance x1 from the zero point of the treatment apparatus as shown in FIG. 7, the variable resistance R is adjusted such that the voltage value V2 is used as the threshold of the comparison unit a2. This adjustment allows the comparison unit a2 to output a detection signal in the range from point P1 at which the slide table 3 has reached the zero point of the treatment apparatus to point P2 at which the voltage value decreases to the voltage value V2 or lower, as shown in graph (4) in FIG. 7. An LED or the like may be provided and switched on in response to the detection signal in order to notify the outside such as an operator that the position detector of the embodiment has detected the slide table 3.

Note that, for the adjustment of the threshold, the slide table 3 is actually moved in one direction, and then actually stopped at the zero point by use of a physical measurement method other than the Hall element. After that, the variable resistance is adjusted such that a detection signal is output to the controller C. Once the threshold is adjusted by adjusting the variable resistance R in this manner, the zero point will be able to be precisely detected by the Hall element from then on.

That is, without physically relocating the Hall element 17b, it can be detected that the slide table 3 has reached the zero point.

The Hall element 17b for detecting the zero point has been described by way of example, but the same can be said of the other Hall elements. Specifically, the threshold of each of the comparison units a2 respectively connected to the Hall elements can be adjusted in order to output a detection signal in a position, such as the zero point, where the corresponding Hall element is assigned for detection. In short, a deviation between the location of a Hall element and the target position is electrically resolved to achieve precise position detection.

In the embodiment the permanent magnet 19 provided on the slide table 3, the Hall elements 16a, 17a, 17b, 17c attached to the mounting base 1 and the amplifier circuit A form the position detector. Then, each of the amplification units a1 of the amplifier circuit A amplifies the voltage supplied from the corresponding Hall element even if the voltage is very low, thereby detecting it as a signal. As a result, even if the permanent magnet is located at a distance from the Hall element, the position of the permanent magnet can be detected. However, the amplification unit a1 is not an essential element for attaining the object of the present invention.

Either the permanent magnet or the Hall elements may be provided on either the slide table 3 or the mounting base 1. However, because signal wires are required to be connected to the Hall elements, if the permanent magnet is mounted on the slide table 3 which moves, this makes the structure simple.

On the other hand, when a Hall element is provided on the slide table 3 and a plurality of permanent magnets are provided on the mounting base 1, it makes it possible to use a single Hall element to detect a plurality of positions.

In addition, in the aforementioned embodiment a “0” signal is output as a detection signal from the amplifier circuit A when the Hall element detects the permanent magnet and a “1” signal is output when the Hall element does not detect it. However, a “0” signal may be output when the Hall element does not detect the permanent magnet and a “1” signal may be output when the Hall element detects it. In the case of a position detector comprising a plurality of Hall elements, a “0” signal and a “1 ” signal may be used in combination as the detection signal.

In a system outputting a “1” signal when the slide table 3 is detected, power saving can be achieved as compared with the case where a “1” level signal is continuously output when the slide table 3 is not detected, because a signal is not required to be output except when the slide table 3 is detected. However, if a portion of the amplifier circuit A corresponding to any Hall element is configured to output a “1” level signal in the case of non-detection, this offers the advantage that an abnormal electrical state such as a broken wire, a power failure or the like can be detected, because a signal is output at the time of turning the power on even when the position of the slide table 3 is not detected.

The position detector of the embodiment is capable of not only correcting a positional deviation caused by the impossibility to maintain the desired positional relationship when the position detector is installed in a treatment apparatus or the like, but also changing the detection position whenever required during use of the apparatus. For example, the zero point of the treatment apparatus can be changed in accordance with a change in workpiece. Alternatively, the detection position of the stroke end can be changed for the purpose of changing the range in which the slide table moves.

In the embodiment, the path of movement of the moving object of the present invention is ensured by the use of rails. However, as long as the moving object can be moved along a predetermined path, a guiding member such as rails need not be provided.

What is claimed is:

1. A position detector provided with either a permanent magnet or Hall elements mounted on a moving object which moves along a fixed path of movement, with the other of two, the permanent magnet and the Hall elements, mounted on the fixed path of movement of the moving object, and detecting a voltage output from each of the Hall elements on the basis of an electromotive force induced in the Hall element in accordance with a facing position between the permanent magnet and the Hall element in order to detect the position of the moving object, the position detector comprising,
a comparison unit comparing a voltage value supplied from the Hall element with a threshold, outputting a detection signal when the voltage value exceeds the threshold for detection of a position of the moving object from a position in which the detection signal is output, and comprising a variable controlling unit for variably controlling the threshold.

2. A position detector according to claim 1, wherein the variable controlling unit comprises a variable resistance.

3. A position detector according to claim 1, further comprising an amplification unit provided between the Hall element and the comparison unit for amplifying a voltage supplied from the Hall element and outputting the voltage thus amplified.

4. A position detector according to claim 2, further comprising an amplification unit provided between the Hall element and the comparison unit for amplifying a voltage supplied from the Hall element and outputting the voltage thus amplified.
